(19) United States
(12) Patent Application Publication
(10) Pub. No.: US 2010/0314885 A1
(43) Pub. Date: Dec. 16, 2010

(54) SHROUDED WIND TURBINE WITH RIM GENERATOR AND HALBACH ARRAY

(75) Inventors: Walter M. Presz, JR., Wilbraham, MA (US); Michael J. Werle, West Hartford, CT (US); Thomas J. Kennedy, III, Wilbraham, MA (US)

Correspondence Address: FAY SHARPE LLP, 1228 Euclid Avenue, 5th Floor, The Halle Building, Cleveland, OH, 44115, US

(73) Assignee: FLODESIGN WIND TURBINE CORPORATION, Wilbraham, MA (US)

(21) Appl. No.: 12/828,698

(22) Filed: Jul. 1, 2010

Related U.S. Application Data
(63) Continuation-in-part of application No. 12/054,050, filed on Mar. 24, 2008.
Application No. 12/054,050 is a continuation-in-part of application No. 12/629,714, filed on Dec. 2, 2009.
(60) Provisional application No. 61/222,142, filed on Jul. 1, 2009.
(60) Provisional application No. 60/919,588, filed on Mar. 23, 2007.
(60) Provisional application No. 61/119,078, filed on Dec. 2, 2008.

(51) Int. Cl. F03D 9/00

(52) U.S. Cl. 290/55

(57) ABSTRACT

A wind turbine comprises a turbine shroud and optionally an ejector shroud. The wind turbine encloses a permanent magnet ring generator. A static ring of phase windings is located in the turbine shroud, and wind airflow causes a rotor having permanent magnets thereon to rotate, creating an electric current in the static ring. The permanent magnets are arranged to form a Halbach cylinder with the magnetic field being exterior to the rotor.

This application claims priority to U.S. Provisional Patent Application Ser. No. 61/222,142, filed Jul. 1, 2009. This application is also a continuation-in-part from U.S. patent application Ser. No. 12/054,050, filed Mar. 24, 2008, which claimed priority from U.S. Provisional Patent Application Ser. No. 60/919,588, filed Mar. 23, 2007. This application is also a continuation-in-part from U.S. patent application Ser. No. 12/629,714, filed Dec. 2, 2009, which claimed priority from U.S. Provisional Patent Application Ser. No. 61/119,078, filed Dec. 2, 2008. The disclosures of these applications are hereby fully incorporated by reference in their entirety.

### BACKGROUND

The present disclosure relates to rim generators for use with a shrouded wind turbine. In particular, a ring generator based on a rotor/stator assembly is modified to serve as a permanent magnet generator. The magnets included in the ring generator are arranged in a Halbach array in order to enhance power generation by the shrouded wind turbine. Methods of making and using such systems are also disclosed.

Conventional wind turbines used for power generation generally have two to five open blades arranged like a propeller, the blades being mounted to a horizontal shaft attached to a gear box which drives a power generator. Such turbines are generally known as horizontal axis wind turbines, or HAWTs. Although HAWTs have achieved widespread usage, their efficiency is not optimized. In particular, they will not exceed the Betz limit of 59.3% efficiency in capturing the potential energy of the wind passing through it. These turbines typically require a supporting tower ranging from 60 to 90 meters in height. The blades generally rotate at a rotational speed of about 10 to 22 rpm. A gear box is commonly used to step up the speed to drive the generator, although some designs may directly drive an annular electric generator. Some turbines operate at a constant speed. However, more energy can be collected by using a variable speed turbine and a solid state power converter to interface the turbine with the generator.

It would be desirable to collect additional energy from the wind turbine.

### BRIEF DESCRIPTION

The present disclosure relates to shrouded wind turbines comprising a ring generator. The permanent magnets in the ring generator are arranged in a Halbach array to maximize the power generation capability of the wind turbine.

Disclosed in embodiments is a wind turbine comprising: a turbine shroud and an impeller. The turbine shroud encloses or surrounds the impeller. The turbine shroud also includes a static ring that has at least one phase winding. The impeller comprises a rotor. The rotor has a central ring, an outer ring, a plurality of rotor blades extending between the central ring and the outer ring, and a plurality of permanent magnets on the outer ring. The static ring of the turbine shroud and the outer ring of the rotor are aligned with each other. The plurality of permanents magnets are arranged on the outer ring to form a Halbach cylinder that produces a magnetic field exterior to the rotor.

The turbine shroud may further comprise a ring of mixing lobes formed on a trailing edge. A trailing edge of the turbine shroud may have a circular crenellated shape.

The permanent magnets may comprise a rare earth element. In particular embodiments, the permanent magnets are Nd₂Fe₁₄B magnets. The plurality of permanent magnets may more specifically be located along a rear end of the outer ring.

In embodiments, the static ring has three phase windings connected in series.

The wind turbine may further comprise an ejector shroud, an inlet end of the ejector shroud surrounding an outlet end of the turbine shroud. The wind turbine may also further comprise a stator defining an inlet end of the wind turbine, the stator comprising a plurality of stator vanes.

Disclosed in other embodiments is a wind turbine comprising: a turbine shroud, an impeller, and an ejector shroud. The turbine shroud encloses or surrounds the impeller. The turbine shroud also includes a static ring that has at least one phase winding. The impeller comprises a rotor. The rotor has a central ring, an outer ring, a plurality of rotor blades extending between the central ring and the outer ring, and a plurality of permanent magnets on the outer ring. The static ring of the turbine shroud and the outer ring of the rotor are aligned with each other. The plurality of permanents magnets are arranged on the outer ring to form a Halbach cylinder that produces a magnetic field exterior to the rotor. An inlet end of the ejector shroud surrounds an outlet end of the turbine shroud.

In particular embodiments, the turbine shroud further comprises a ring of mixing lobes formed on a trailing edge, and the ejector shroud has an airfoil shape (i.e. the ejector shroud does not have mixing lobes).

Also disclosed is a wind turbine comprising: a turbine shroud enclosing an impeller; wherein the turbine shroud encloses a static ring that has at least one phase winding and has a ring of mixing lobes formed on a trailing edge; wherein the impeller comprises a stator and a rotor, the stator being upstream of the rotor and the rotor having a central ring, an outer ring, a plurality of rotor blades extending between the central ring and the outer ring, and a plurality of permanent magnets on the outer ring; wherein the static ring and the outer ring are aligned with each other; and wherein the plurality of permanents magnets are arranged on the outer ring to form a Halbach cylinder that produces a magnetic field exterior to the rotor; and an ejector shroud having an airfoil shape, an inlet end of the ejector shroud surrounding an outlet end of the turbine shroud.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is an exploded view of a first exemplary embodiment or version of a MEWT of the present disclosure.

FIG. 2 is a front perspective view of FIG. 1 attached to a support tower.

FIG. 3 is a front perspective view of a second exemplary embodiment of a MEWT, shown with a shrouded three bladed impeller.

FIG. 4 is a rear view of the MEWT of FIG. 3.

FIG. 5 is a front perspective view of another exemplary embodiment of a MEWT according to the present disclosure.

FIG. 6 is a side cross-sectional view of the MEWT of FIG. 5 taken through the turbine axis.

FIG. 7 is a smaller view of FIG. 6.

FIG. 7A and FIG. 7B are magnified views of the mixing lobes of the MEWT of FIG. 7.

FIG. 8 is a cutaway view of another exemplary embodiment of a MEWT showing the static ring portion of a ring generator.

FIG. 9 is a cutaway view of another exemplary embodiment of a MEWT showing the rotor portion of a ring generator.

FIG. 10 is a closeup view of the static ring portion of a ring generator having three phase windings.

FIG. 11 is the front view of an exemplary static ring.

FIG. 12 is the side view of an exemplary static ring.

FIG. 13 is the front view of an exemplary rotor.

FIG. 14 is the side view of an exemplary rotor.

FIG. 15 is a closeup view showing the rotor and the static ring of a ring generator in relation to each other.

### DETAILED DESCRIPTION

A more complete understanding of the components, processes, and apparatuses disclosed herein can be obtained by reference to the accompanying figures. These figures are merely schematic representations based on convenience and the ease of demonstrating the present development and are, therefore, not intended to indicate the relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

A Mixer-Ejector Power System (MEPS) provides a unique and improved means of generating power from wind currents. A MEPS includes:
a primary shroud containing a turbine or bladed impeller, similar to a propeller, which extracts power from the primary stream; and
a single or multiple-stage mixer-ejector to ingest flow with each such mixer/ejector stage including a mixing duct for both bringing in secondary flow and providing flow mixing-length for the ejector stage. The inlet contours of the mixing duct or shroud are designed to minimize flow losses while providing the pressure forces necessary for good ejector performance.

The resulting mixer/ejectors enhance the operational characteristics of the power system by: (a) increasing the amount of flow through the system, (b) reducing the exit or back pressure on the turbine blades, and (c) reducing the noise propagating from the system.

The MEPS may include:
camber to the duct profiles to enhance the amount of flow into and through the system;
acoustical treatment in the primary and mixing ducts for noise abatement flow guide vanes in the primary duct for control of flow swirl and/or mixer-lobes tailored to diminish flow swirl effects;
turbine-like blade aerodynamics designs based on the new theoretical power limits to develop families of short, structurally robust configurations which may have multiple and/or counter-rotating rows of blades;
exit diffusers or nozzles on the mixing duct to further improve performance of the overall system;
inlet and outlet areas that are non-circular in cross section to accommodate installation limitations;
a swivel joint on its lower outer surface for mounting on a vertical stand/pylon allowing for turning the system into the wind;
vertical aerodynamic stabilizer vanes mounted on the exterior of the ducts with tabs or vanes to keep the system pointed into the wind; or
mixer lobes on a single stage of a multi-stage ejector system.

Referring to the drawings in detail, the figures illustrate alternate embodiments of Applicants' axial flow Wind Turbine with Mixers and Ejectors (“MEWT”).

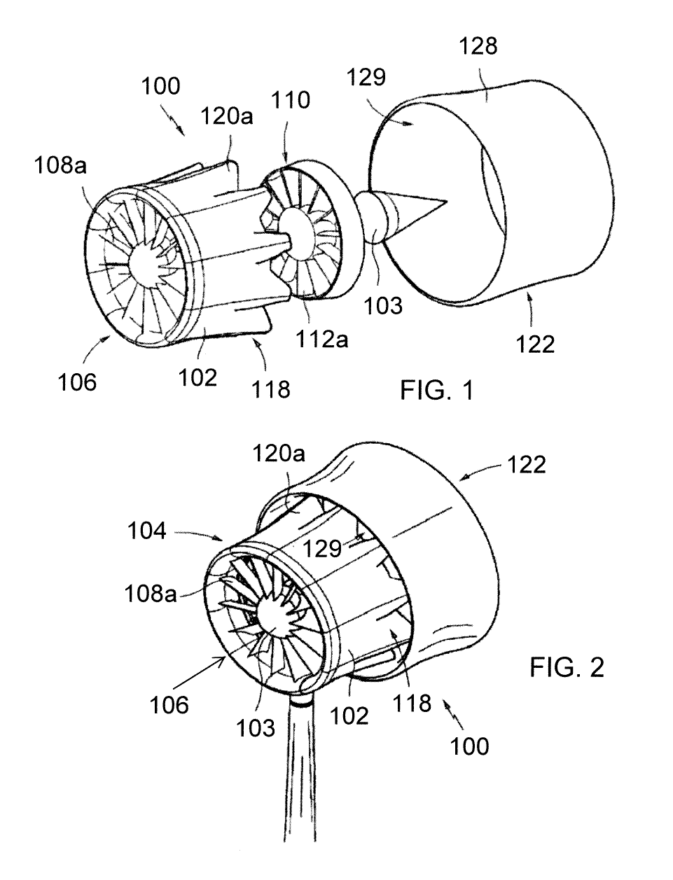

Referring to FIG. 1 and FIG. 2, the MEWT 100 is an axial flow turbine with:

a) an aerodynamically contoured turbine shroud 102;

b) an aerodynamically contoured center body 103 within and attached to the turbine shroud 102;

c) a turbine stage 104, surrounding the center body 103, comprising a stator ring 106 having stator vanes 108a and a rotor 110 having rotor blades 112a. Rotor 110 is downstream and “in-line” with the stator vanes, i.e., the leading edges of the impeller blades are substantially aligned with trailing edges of the stator vanes, in which:
i) the stator vanes 108a are mounted on the center body 103;
ii) the rotor blades 112a are attached and held together by inner and outer rings or hoops mounted on the center body 103;

d) a mixer indicated generally at 118 having a ring of mixer lobes 120a on a terminus region (i.e., end portion) of the turbine shroud 102, wherein the mixer lobes 120a extend downstream beyond the rotor blades 112a; and,

e) an ejector indicated generally at 122 comprising an ejector shroud 128, surrounding the ring of mixer lobes 120a on the turbine shroud, wherein the mixer lobes (e.g., 120a) extend downstream and into an inlet 129 of the ejector shroud 128.

The center body 103 of MEWT 100, as shown in FIG. 2, is desirably connected to the turbine shroud 102 through the stator ring 106, or other means. This construction serves to eliminate the damaging, annoying and long distance propagating low-frequency sound produced by traditional wind turbines as the wake from the turbine blades strike the support tower. The aerodynamic profiles of the turbine shroud 102 and ejector shroud 128 are aerodynamically cambered to increase flow through the turbine rotor.

Applicants have calculated, for optimum efficiency, the area ratio of the ejector pump 122, as defined by the ejector shroud 128 exit area over the turbine shroud 102 exit area, will be in the range of 1.5-3.0. The number of mixer lobes 120a would be between 6 and 14. Each lobe will have inner and outer trailing edge angles between 5 and 65 degrees. These angles are measured from a tangent line that is drawn at the exit of the mixing lobe down to a line that is parallel to the center axis of the turbine, as will be explained further herein. The primary lobe exit location will be at, or near, the entrance location or inlet 129 of the ejector shroud 128. The height-to-width ratio of the lobe channels will be between 0.5 and 4.5. The mixer penetration will be between 50% and 80%. The center body 103 plug trailing edge angles will be thirty degrees or less. The length to diameter (L/D) of the overall MEWT 100 will be between 0.5 and 1.25.

First-principles-based theoretical analysis of the preferred MEWT 100, performed by Applicants, indicate the MEWT can produce three or more times the power of its un-shrouded counterparts for the same frontal area; and, the MEWT 100 can increase the productivity of wind farms by a factor of two or more. Based on this theoretical analysis, it is believed the MEWT embodiment 100 will generate three times the existing power of the same size conventional open blade wind turbine.

A satisfactory embodiment 100 of the MEWT comprises: an axial flow turbine (e.g., stator vanes and impeller blades) surrounded by an aerodynamically contoured turbine shroud 102 incorporating mixing devices in its terminus region (i.e., end portion); and a separate ejector shroud 128 overlapping, but aft, of turbine shroud 102, which itself may incorporate mixer lobes in its terminus region. The ring 118 of mixer lobes 120a combined with the ejector shroud 128 can be thought of as a mixer/ejector pump. This mixer/ejector pump provides the means for consistently exceeding the Betz limit for operational efficiency of the wind turbine. The stator vanes' exit-angle incidence may be mechanically varied in situ (i.e., the vanes are pivoted) to accommodate variations in the fluid stream velocity so as to assure minimum residual swirl in the flow exiting the rotor.

Described differently, the MEWT 100 comprises a turbine stage 104 with a stator ring 106 and a rotor 110 mounted on center body 103, surrounded by turbine shroud 102 with embedded mixer lobes 120a having trailing edges inserted slightly in the entrance plane of ejector shroud 128. The turbine stage 104 and ejector shroud 128 are structurally connected to the turbine shroud 102, which is the principal load carrying member.

These figures depict a rotor/stator assembly for generating power. The term “impeller” is used herein to refer generally to any assembly in which blades are attached to a shaft and able to rotate, allowing for the generation of power or energy from wind rotating the blades. Exemplary impellers include a propeller or a rotor/stator assembly. Any type of impeller may be enclosed within the turbine shroud 102 in the wind turbine of the present disclosure.

In some embodiments, the length of the turbine shroud 102 is equal or less than the turbine shroud's outer maximum diameter. Also, the length of the ejector shroud 128 is equal or less than the ejector shroud's outer maximum diameter. The exterior surface of the center body 103 is aerodynamically contoured to minimize the effects of flow separation downstream of the MEWT 100. It may be configured to be longer or shorter than the turbine shroud 102 or the ejector shroud 128, or their combined lengths.

The turbine shroud's entrance area and exit area will be equal to or greater than that of the annulus occupied by the turbine stage 104, but need not be circular in shape so as to allow better control of the flow source and impact of its wake. The internal flow path cross-sectional area formed by the annulus between the center body 103 and the interior surface of the turbine shroud 102 is aerodynamically shaped to have a minimum area at the plane of the turbine and to otherwise vary smoothly from their respective entrance planes to their exit planes. The turbine and ejector shrouds' external surfaces are aerodynamically shaped to assist guiding the flow into the turbine shroud inlet, eliminating flow separation from their surfaces, and delivering smooth flow into the ejector entrance 129. The ejector 128 entrance area, which may alternatively be noncircular in shape, is greater than the mixer 118 exit plane area; and the ejector's exit area may also be noncircular in shape if desired.

Optional features of the preferred embodiment 100 can include: a power take-off, in the form of a wheel-like structure, which is mechanically linked at an outer rim of the impeller to a power generator; a vertical support shaft with a rotatable coupling for rotatably supporting the MEWT, the shaft being located forward of the center-of-pressure location on the MEWT for self-aligning the MEWT; and a self-moving vertical stabilizer fin or “wing-tab” affixed to upper and lower surfaces of the ejector shroud to stabilize alignment directions with different wind streams.

The MEWT 100, when used near residences can have sound absorbing material affixed to the inner surface of its shrouds 102, 128 to absorb and thus eliminate the relatively high frequency sound waves produced by the interaction of the stator 106 wakes with the rotor 110. The MEWT 100 can also contain blade containment structures for added safety. The MEWT should be considered to be a horizontal axis wind turbine as well.

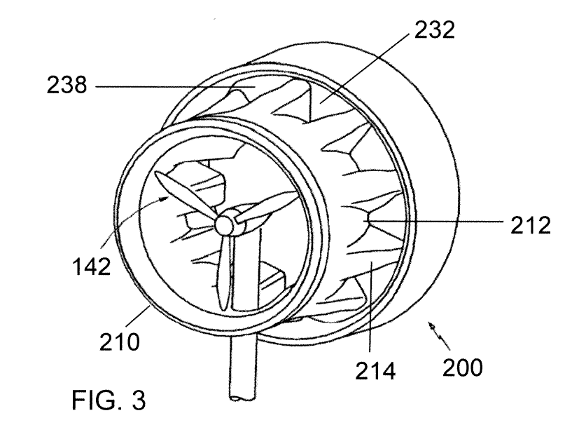

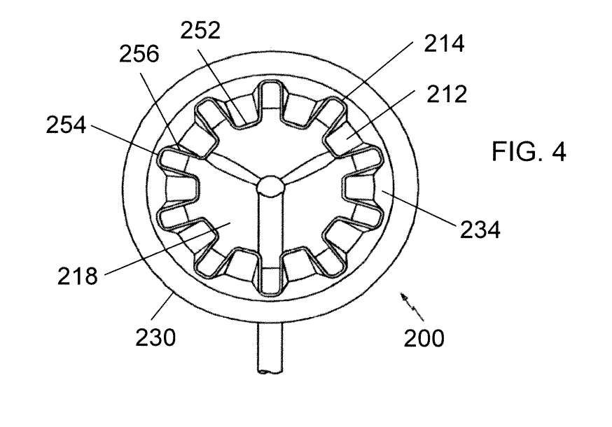

FIG. 3 and FIG. 4 show a second exemplary embodiment of a shrouded wind turbine 200. The turbine 200 uses a propeller-type impeller 142 instead of the rotor/stator assembly used in FIG. 1 and FIG. 2. In addition, the mixing lobes can be more clearly seen in this embodiment. The turbine shroud 210 has two different sets of mixing lobes. Referring to FIG. 3 and FIG. 4, the turbine shroud 210 has a set of high energy mixing lobes 212 that extend inwards toward the central axis of the turbine. In this embodiment, the turbine shroud is shown as having 10 high energy mixing lobes. The turbine shroud also has a set of low energy mixing lobes 214 that extend outwards away from the central axis. Again, the turbine shroud 210 is shown with 10 low energy mixing lobes. The high energy mixing lobes alternate with the low energy mixing lobes around the trailing edge of the turbine shroud 210. The impeller 142, turbine shroud 210, and ejector shroud 230 are coaxial with each other, i.e. they share a common central axis.

From the rear, as seen in FIG. 4, the trailing edge of the turbine shroud may be considered as having a circular crenellated shape.

The trailing edge 250 can be considered as including several inner circumferentially spaced arcuate portions 252 which each have the same radius of curvature. Those inner arcuate portions are preferably evenly spaced apart from each other. In those spaces between portions 252 are several outer arcuate portions 254, which each have the same radius of curvature. The radius of curvature for the inner arcuate portions is different from the radius of curvature for the outer arcuate portions 254, but the inner arcuate portions and outer arcuate portions should share generally the same center (i.e. along the central axis). The inner portions 252 and the outer arcuate portions 254 are then connected to each other by radially extending portions 256. This results in a circular crenellated shape. The term “crenellated” or “castellated” are not used herein as requiring the inner arcuate portions, outer arcuate portions, and radially extending portions to be straight lines, but rather to refer to the general up-and-down or in-and-out shape of the trailing edge 250. This crenellated structure forms two sets of mixing lobes, high energy mixing lobes 212 and low energy mixing lobes 214.

The entrance area 232 of the ejector shroud 230 is larger than the exit area 234 of the ejector shroud. It will be understood that the entrance area refers to the entire mouth of the ejector shroud and not the annular area of the ejector shroud between the ejector shroud 230 and the turbine shroud 210. However, as seen further herein, the entrance area of the ejector shroud may also be smaller than the exit area 234 of the ejector shroud. As expected, the entrance area 232 of the ejector shroud 230 is larger than the exit area 218 of the turbine shroud 210, in order to accommodate the mixing lobes and to create an annular area 238 between the turbine shroud and the ejector shroud through which high energy air can enter the ejector.

As shown here, mixing lobes are present on the turbine shroud. If desired, mixing lobes may also be formed on a trailing edge of the ejector shroud.

The mixer-ejector design concepts described herein can significantly enhance fluid dynamic performance. These mixer-ejector systems provide numerous advantages over conventional systems, such as: shorter ejector lengths; increased mass flow into and through the system; lower sensitivity to inlet flow blockage and/or misalignment with the principal flow direction; reduced aerodynamic noise; added thrust; and increased suction pressure at the primary exit.

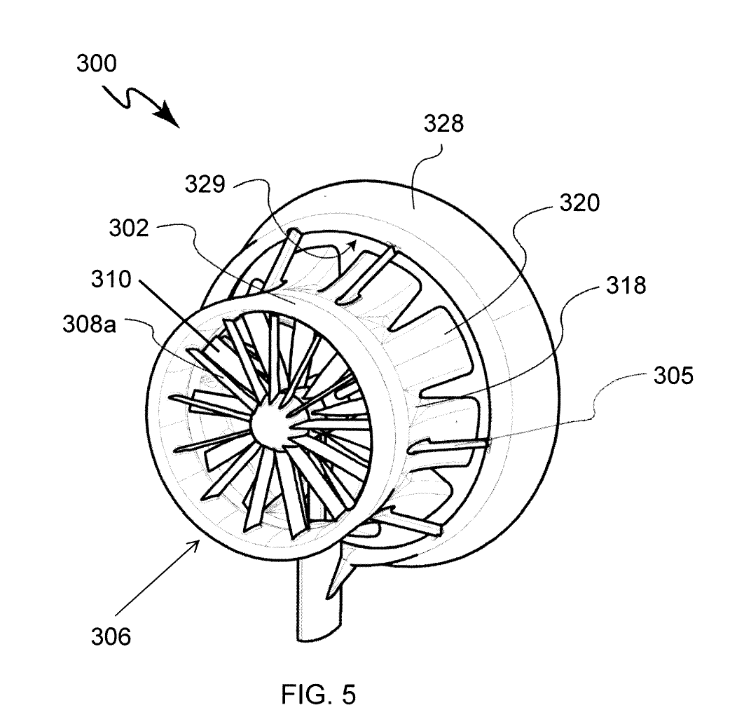

FIGS. 5-7 illustrate another exemplary embodiment of a MEWT. The MEWT 300 in FIG. 5 has a stator 308a and rotor 310 configuration for power extraction. A turbine shroud 302 surrounds the rotor 310 and is supported by or connected to the blades or spokes of the stator 308a. The turbine shroud 302 has the cross-sectional shape of an airfoil with the suction side (i.e. low pressure side) on the interior of the shroud. An ejector shroud 328 is coaxial with the turbine shroud 302 and is supported by connector members 305 extending between the two shrouds. An annular area is thus formed between the two shrouds. The rear or downstream end of the turbine shroud 302 is shaped to form two different sets of mixing lobes 318, 320. High energy mixing lobes 318 extend inwardly towards the central axis of the mixer shroud 302; and low energy mixing lobes 320 extend outwardly away from the central axis.

Free stream air indicated generally by arrow 306 passing through the stator 308a has its energy extracted by the rotor 310. High energy air indicated by arrow 329 bypasses the shroud 302 and stator 308a and flows over the turbine shroud 302 and directed inwardly by the high energy mixing lobes 318. The low energy mixing lobes 320 cause the low energy air exiting downstream from the rotor 310 to be mixed with the high energy air 329.

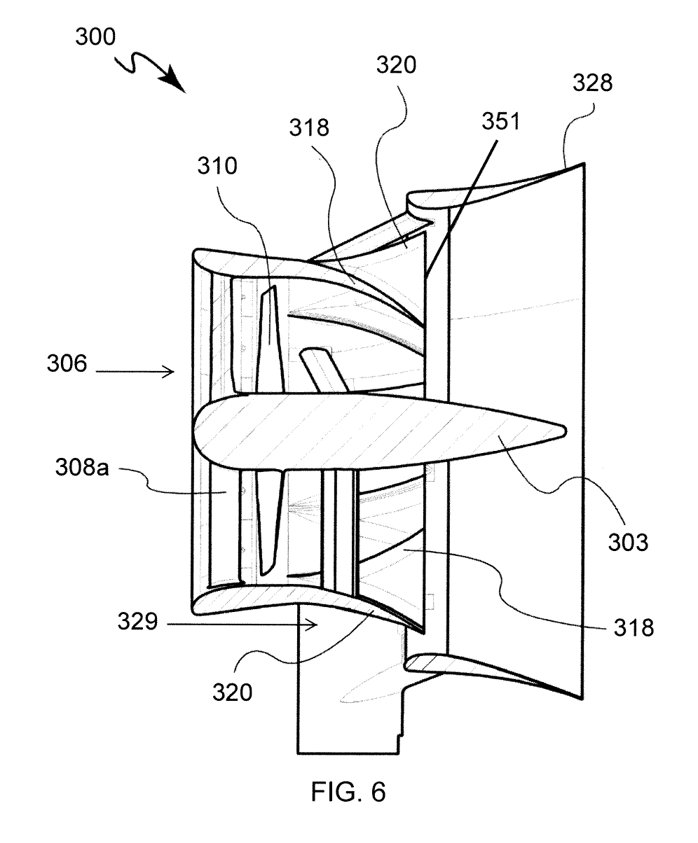

Referring to FIG. 6, the center nacelle 303 and the trailing edges of the low energy mixing lobes 320 and the trailing edge of the high energy mixing lobes 318 are shown in the axial cross-sectional view of the turbine of FIG. 5. The ejector shroud 328 is used to direct inwardly or draw in the high energy air 329. Optionally, nacelle 303 may be formed with a central axial passage therethrough to reduce the mass of the nacelle and to provide additional high energy turbine bypass flow.

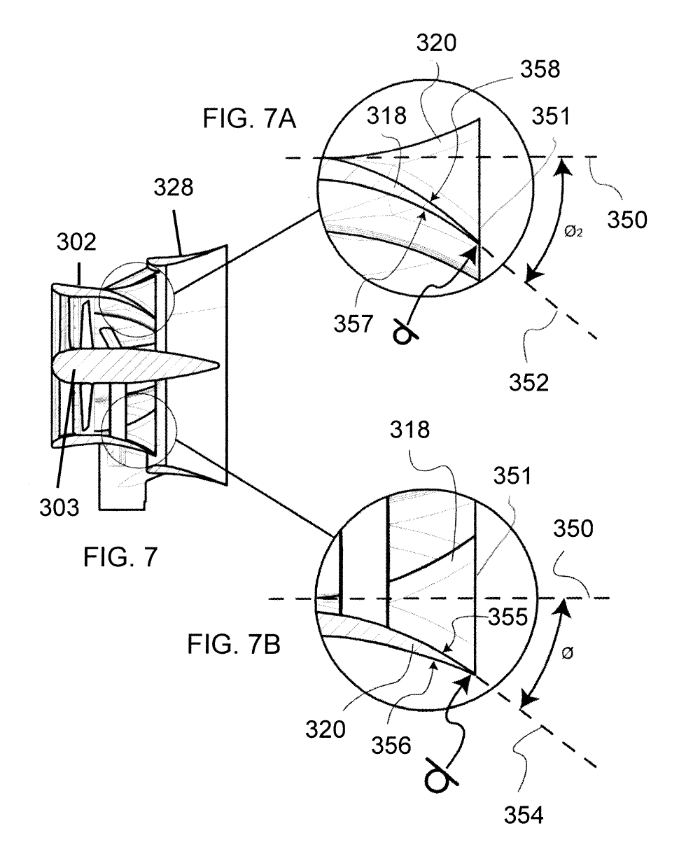

In FIG. 7A, a tangent line 352 is drawn along the interior trailing edge indicated generally at 357 of the high energy mixing lobe 318. A rear plane 351 of the turbine shroud 302 is present. A line 350 is formed normal to the rear plane 351 and tangent to the point where a low energy mixing lobe 320 and a high energy mixing lobe 318 meet. An angle Ø₂ is formed by the intersection of tangent line 352 and line 350. This angle Ø₂ is between 5 and 65 degrees. Put another way, a high energy mixing lobe 318 forms an angle Ø₂ between 5 and 65 degrees relative to the turbine shroud 302.

In FIG. 7B, a tangent line 354 is drawn along the interior trailing edge indicated generally at 355 of the low energy mixing lobe 320. An angle Ø is formed by the intersection of tangent line 354 and line 350. This angle Ø is between 5 and 65 degrees. Put another way, a low energy mixing lobe 320 forms an angle Ø between 5 and 65 degrees relative to the turbine shroud 302.

The leading edge of the turbine shroud may be considered the front of the wind turbine, and the trailing edge of the ejector shroud may be considered the rear of the wind turbine. A first component of the wind turbine located closer to the front of the turbine may be considered “upstream” of a second component located closer to the rear of the turbine. Put another way, the second component is “downstream” of the first component.

The shrouded wind turbine of the present disclosure uses a ring generator to capture energy from wind. Essentially, moving magnets are used to generate current in a stationary phase winding. The magnets of the present disclosure are permanent magnets arranged to form a Halbach array. A Halbach array is an arrangement of permanent magnets that increases the magnetic field on one side of the array and cancels the magnetic field on the opposite side of the array to near zero. The Halbach array of magnets can be arranged into a cylindrical form, with the increased magnetic field on the interior or the exterior of the cylinder. This form of a Halbach array is also referred to as a Halbach cylinder. The Halbach cylinder of the present disclosure is arranged so that the magnetic field is on the exterior of the cylinder, as will be further explained herein.

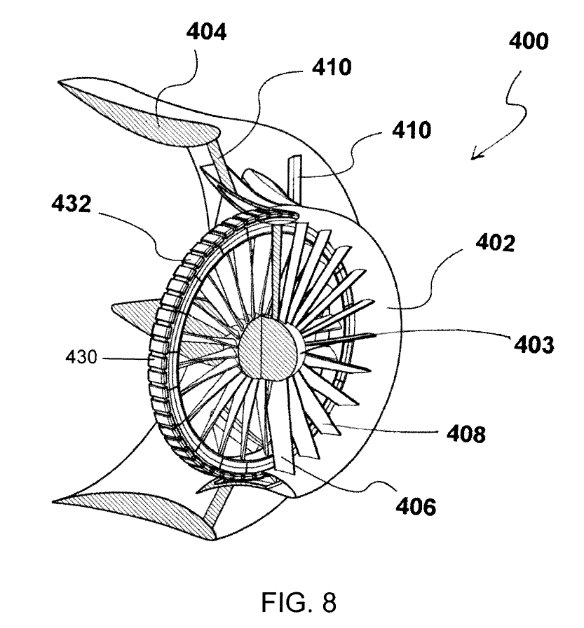

Referring now to FIGS. 8-15, a shrouded wind turbine 400 is shown that uses a ring generator. The turbine 400 comprises a mixer shroud 402 and an ejector shroud 404. The mixer shroud 402 encloses a rotor/stator assembly 406. Stator vanes 408 run between the mixer shroud 402 and a nacelle or center body 403. Attachment struts 410 join or connect the mixer shroud 402 with the ejector shroud 404.

FIG. 8 shows a static ring 430 that is mounted on or within the mixer shroud 402. The static ring is made up of one or more phase windings 432.

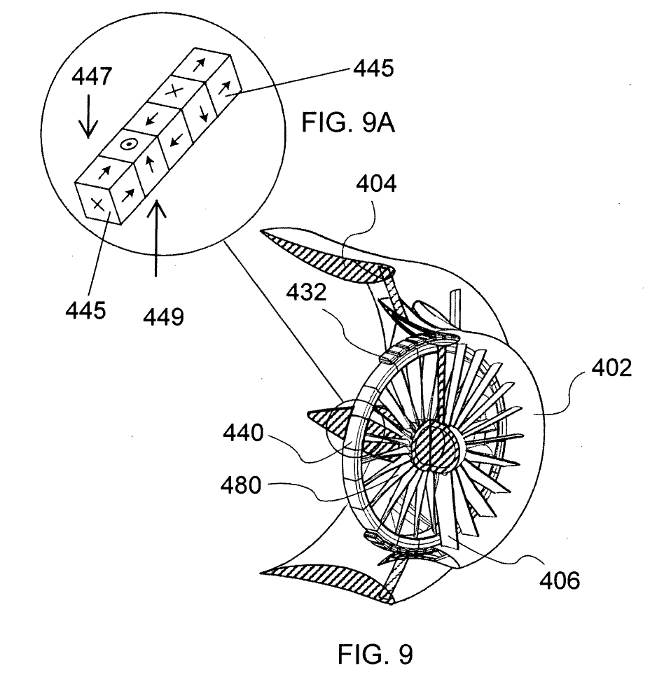

In FIG. 9, part of the static ring is removed to expose permanent magnet arrays 440 which are mounted on the rotor 420. As the rotor rotates, a constant rotating magnetic field is produced by the magnet arrays 440. This magnetic field induces an alternating current (AC) voltage in the phase windings 432 to produce electrical energy which can be captured. One advantage of the permanent ring generator is that it does not need an initial injection of power in order to begin producing electricity.

It should be noted that in the field of electric motors, the word “stator” is used to refer to the stationary portion of a rotor/stator system. The phrase “static ring” is used here to reduce any confusion between the stationary portion 430 of the power generation system in the wind turbine and the stationary vane 408 that direct air against the rotor 420.

FIG. 9A is an enlarged view of some permanent magnets 445. On each magnet is an arrow showing the orientation of the magnetic field. The magnets are arranged in a Halbach array, so that the magnetic field exterior or outside of the rotor (indicated by reference numeral 447) is enhanced, while the magnetic field interior to or inside of the rotor (indicated by reference numeral 449) is decreased to near zero.

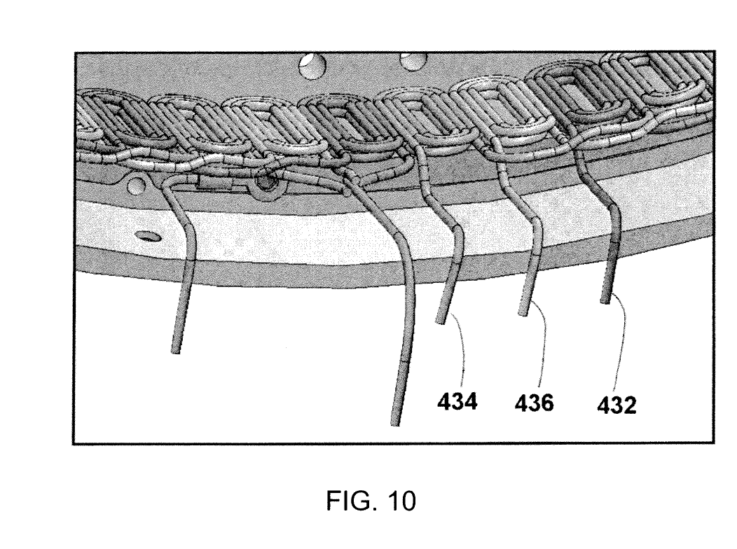

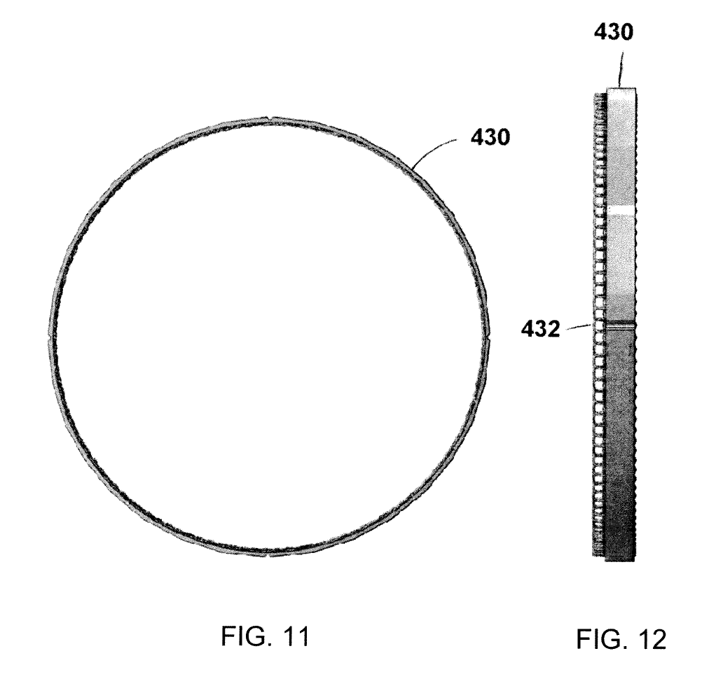

FIG. 10 is an enlarged view of the static ring showing the phase windings 432. Each phase winding is comprised of a series of coils. In particular embodiments such as that depicted here, the stator has three phase windings 432, 434, 436 connected in series for producing three-phase electric power. Each winding contains 40 wound coils in series spaced by nine degrees, so that the combination of three phase windings covers the 360° circumference of the stator. FIG. 11 and FIG. 12 show the assembled stator 430 from the front and side, respectively.

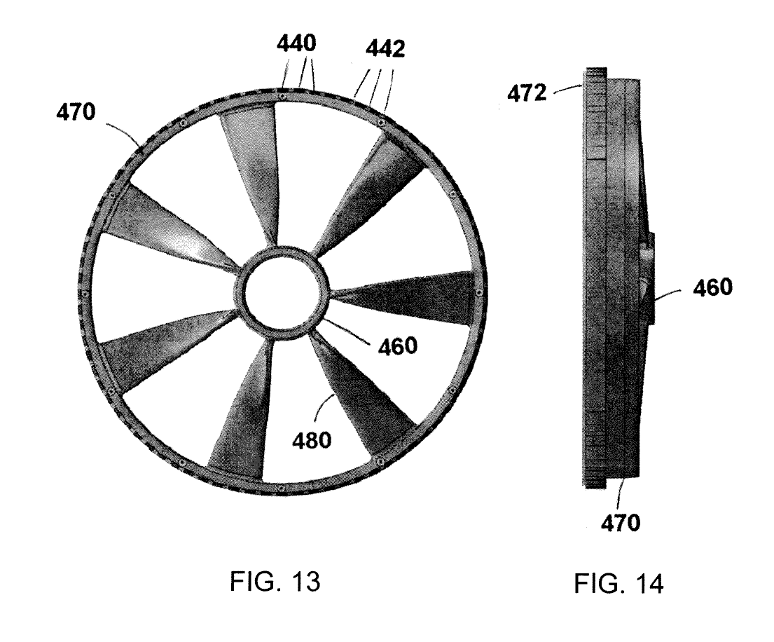

Referring now to FIG. 13 and FIG. 14, the rotor 450 contains a central ring 460 and an outer ring 470. Rotor blades 480 extend between the central ring 460 and the outer ring 470, connecting them together. Referring back to FIG. 9, the center body 403 extends through the central ring 460 to support the rotor 450 and fix its location relative to the mixer shroud 402.

A plurality of permanent magnet arrays 440 is located on the outer ring 470. The magnets are generally evenly distributed around the circumference of the rotor and along the outer ring 470. As seen in FIG. 14, in embodiments the magnet arrays are located along a rear end 472 of the outer ring. The magnet arrays are arranged to form a Halbach cylinder, i.e. with the magnetic field exterior to the outer ring. The magnets 440 are separated by potting material 442 which secures the magnets to the rotor 450. It should be noted that while the overall magnetic field created by the Halbach cylinder is on the exterior of the rotor, the magnetic field itself is generated by a combination of flux lines that alternate in direction, resulting in a magnetic field that can induce AC voltage in the phase windings. Electrical current is generated in the phase windings due to the alternating magnetic field. Because the strength of the generated current is proportional to the magnitude of the magnetic field, the arrangement of the magnets into a Halbach array increases the amount of electrical current generated per rotation of the rotor.

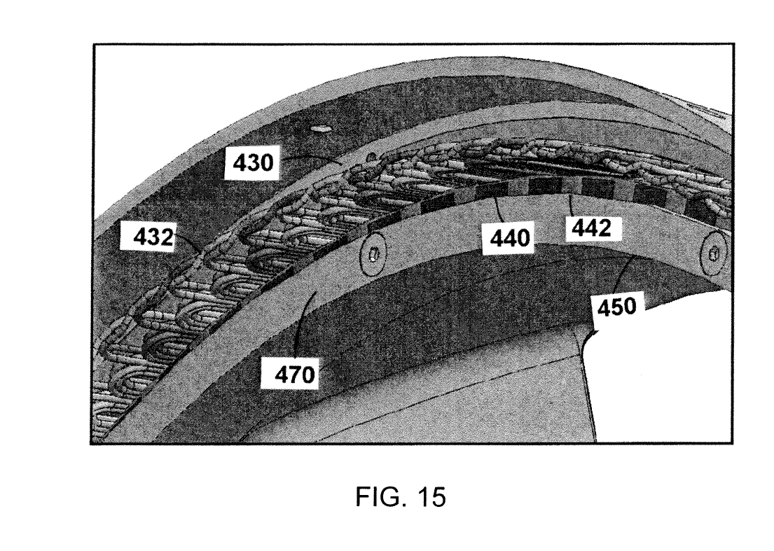

FIG. 15 is an enlarged view showing the rotor 450 and static ring 430 and their relationship to each other. The rotor and static ring are aligned with each other. Put another way, if a radial line is drawn from the central axis of the wind turbine, the rotor and the static ring will be on the same radial line.

Permanent magnets are made from magnetized materials which create their own persistent magnetic field. Exemplary magnetic materials are ferromagnetic and ferromagnetic materials including iron, nickel, cobalt, rare earth metals, and lodestone. Permanent magnets are distinguished from electromagnets which are made up of a wire coil through which an electric current passes to create a magnetic effect.

In some embodiments, the permanent magnets comprise a rare earth metal selected from the group consisting of lanthanum, cerium, praseodymium, neodymium, promethium, samarium, europium, gadolinium, terbium, dysprosium, holmium, erbium, thulium, ytterbium, and lutetium. The rare earth metal magnets may comprise neodymium-iron-boron material such as Nd₂Fe₁₄B or a samarium-cobalt material such as SmCo₅ or SmCo₇.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A wind turbine comprising:
a turbine shroud enclosing an impeller;
wherein the turbine shroud includes a static ring that has at least one phase winding;
wherein the impeller comprises a rotor, the rotor having a central ring, an outer ring, a plurality of rotor blades extending between the central ring and the outer ring, and a plurality of permanent magnets on the outer ring;
wherein the static ring and the outer ring are aligned with each other; and
wherein the plurality of permanents magnets are arranged on the outer ring to form a Halbach cylinder that produces a magnetic field exterior to the rotor.

2. The wind turbine of claim 1, wherein the turbine shroud further comprises a ring of mixing lobes formed on a trailing edge.

3. The wind turbine of claim 1, wherein a trailing edge of the turbine shroud has a circular crenellated shape.

4. The wind turbine of claim 1, wherein the permanent magnets comprise a rare earth element.

5. The wind turbine of claim 1, wherein the permanent magnets are Nd₂Fe₁₄B magnets.

6. The wind turbine of claim 1, wherein the static ring has three phase windings connected in series.

7. The wind turbine of claim 1, wherein the plurality of permanent magnets are located along a rear end of the outer ring.

8. The wind turbine of claim 1, further comprising an ejector shroud, an inlet end of the ejector shroud surrounding an outlet end of the turbine shroud.

9. The wind turbine of claim 1, further comprising a stator defining an inlet end of the wind turbine, the stator comprising a plurality of stator vanes.

10. A wind turbine comprising:
a turbine shroud enclosing an impeller;
wherein the turbine shroud includes a static ring that has at least one phase winding;
wherein the impeller comprises a stator and a rotor, the stator being upstream of the rotor and the rotor having a central ring, an outer ring, a plurality of rotor blades extending between the central ring and the outer ring, and a plurality of permanent magnets on the outer ring;
wherein the static ring and the outer ring are aligned with each other; and
wherein the plurality of permanents magnets are arranged on the outer ring to form a Halbach cylinder that produces a magnetic field exterior to the rotor; and
an ejector shroud, an inlet end of the ejector shroud surrounding an outlet end of the turbine shroud.

11. The wind turbine of claim 10, wherein the turbine shroud further comprises a ring of mixing lobes formed on a trailing edge, and wherein the ejector shroud has an airfoil shape.

12. The wind turbine of claim 10, wherein a trailing edge of the turbine shroud has a circular crenellated shape.

13. The wind turbine of claim 10, wherein the permanent magnets comprise a rare earth element.

14. The wind turbine of claim 10, wherein the permanent magnets are Nd₂Fe₁₄B magnets.

15. The wind turbine of claim 10, wherein the static ring has three phase windings connected in series.

16. The wind turbine of claim 10, wherein the plurality of permanent magnets are located along a rear end of the outer ring.

17. A wind turbine comprising:
a turbine shroud enclosing an impeller;
wherein the turbine shroud encloses a static ring that has at least one phase winding and has a ring of mixing lobes formed on a trailing edge;
wherein the impeller comprises a stator and a rotor, the stator being upstream of the rotor and the rotor having a central ring, an outer ring, a plurality of rotor blades extending between the central ring and the outer ring, and a plurality of permanent magnets on the outer ring;
wherein the static ring and the outer ring are aligned with each other; and
wherein the plurality of permanents magnets are arranged on the outer ring to form a Halbach cylinder that produces a magnetic field exterior to the rotor; and
an ejector shroud having an airfoil shape, an inlet end of the ejector shroud surrounding an outlet end of the turbine shroud.
